(19) United States
(12) Patent Application Publication
(10) Pub. No.: US 2006/0281397 A1
(43) Pub. Date: Dec. 14, 2006

(54) Lifo storage device which is used to receive and dispense coins or tokens

(75) Inventors: Perfecte Sanchis Franch, Ripollet (ES); Josep Clapers Dave, Ripollet (ES); Marc Valls Sampons, Ripollet (ES)

Correspondence Address: FLESHNER & KIM, LLP, P.O. BOX 221200, CHANTILLY, VA, 20153, US

(73) Assignee: ENCOPIM SL, Ripollet (ES)

(21) Appl. No.: 10/554,719

(22) PCT Filed: Apr. 30, 2004
(86) PCT No.: PCT/ES04/00191

§ 371 Date: Jul. 10, 2006

(30) Foreign Application Priority Data
Apr. 30, 2003 (ES) P200301000

(51) Int. Cl. G07D 3/00

(52) U.S. Cl. 453/12

(57) ABSTRACT

The invention relates to a LiFO storage device which is used to receive and dispense coins or tokens. The inventive device comprises at least one tube (1), an upper opening (2) which is disposed in the aforementioned tube (1), an inlet conduit (3), a movable support (4), actuation means and release means. The invention is characterised in that at least two of the above-mentioned tubes (1) form a tube assembly (1) which is arranged around a screw (6). The invention is further characterised in that it also comprises: respective movable supports (4) inside the tubes (1), which are connected to a nut (5) and screw (7) mechanism; a support (7); and actuation means.

### FIELD OF THE INVENTION

The present invention relates to a large capacity LIFO storage device which is used to receive or collect and dispense coins or tokens. The device comprises a plurality of storage tubes for the same kind of coins or tokens, and means for introducing or removing coins or tokens sequentially into/from each of said tubes.

The device according to the invention is particularly, but not exclusively, applicable to vending machines that operate with coins or tokens and that are able to return change.

### TECHNICAL BACKGROUND

Different coins or tokens storage devices are well known that are fitted with mechanisms adapted for receiving and dispensing coins or tokens, and which are applied, for example, to vending machines. One of the systems used includes storage boxes where the coins or tokens are disorganised, and where specific coin or token removal means are provide. There are two other main logistics concepts for this type of device: FIFO logistics (term derived from the English expression “first in first out”, where the first element to reach storage is the first to exit, and LIFO logistics (term derived from the English expression “last in first out”, where the last element to reach storage is the first to exit. In the case of coins or tokens are usually stored in vertical tubular elements, or elements that are slightly tilted with respect to the vertical, where FIFO logistics imply that coins or tokens enter into the corresponding storage tube through one of the ends thereof, or inlet end, and exit from the other end, or exit end, while LIFO logistics imply that coins or tokens enter and exit the corresponding tube at the same inlet and exit end. In a FIFO system, the upper end of the tube is usually used as the inlet end, and the lower end of the tube is used as the exit end so as to avail of a natural gravitational downward flow of coins or tokens. With a LIFO system, on the other hand, either the inlet or exit flow of coins works against gravity and needs the assistance of a mechanical drive.

However, in vending machines or the like that operate with coins or tokens and are capable of returning change, using storage, collection and return devices with LIFO logistics has certain advantages. First of all, these machines allow the coin insertion groove and the change collection box to be a short distance apart, which is an advantage from the point of view of ergonomics. On the other hand, the LIFO system makes it unnecessary to incorporate an anti-fraud device, known in the technical sector as “scrow”, which is provided, for example, to prevent anyone from trying to change false coins for genuine ones by inserting one or more false coins and immediately cancelling the operation, therefore causing the device to return the collected total. In the LIFO system, the same false coins are returned by the system's own logistics.

In the state of the art, storage devices are known that are adapted to receive and dispense coins or tokens using LIFO logistics.

Patent EP-A-0173119 (and its equivalent U.S. Pat. No. 4,687,084) describes a device that is used to store coins and give change, which comprises a coin storage tube inside which the coins are stacked. The said tube has an upper inlet and exit opening and a mobile interior support to support and move the stack of coins up and down inside the tube. The mobile support is driven by a motor and a rack and pinion mechanism, where the rack is made up of an axial rod connected to the mobile support that projects from the lower end of the tube. When the stack is moved downwards space is provided near said upper open end to admit new coins or tokens, and when the stack is moved upwards, the top coin or token in the stack is placed outside the tube, in an expulsion position. In this case, the tube is tilted in relation to the vertical to facilitate the gravitational drop of the coin in said expulsion position.

Document WO 91/07734 discloses a device which is used to store coins and give change that consists of a coin stacking tube with an upper inlet and exit opening. It includes a mobile support to move the stack of coins up or down inside the tube. The mobile support is connected to a nut coupled to a spindle that is substantially parallel to the tube, and the spindle is driven by an electric motor so as to rotate in both directions. The connection between the mobile support and the nut is achieved by means of an arm arranged to move along a longitudinal groove in the tube's cylindrical wall. Adjacent to the upper inlet and exit end a transversal thrusting device is provided that is driven by a crank driven mechanism to expel the coin lying at the top of the pile once said movement means have placed said coin in an expulsion position. This document provides alternative mechanisms for driving the mobile support, such as a spindle connected to the mobile support in coaxial position with respect to the tube and a nut coupled to the spindle underneath the tube and driven by an electric motor or a flexible thrusting rod connected to the lower part of the mobile support and driven by friction rollers.

Patent GB-A-2 278 221 describes a device which is used to store coins and give change, which consists in a coin stacking tube with an upper inlet and exit opening. It comprises means for moving the stack of coins up and down inside the tube, which include a mobile support located inside the tube to support the stack of coins, the mobile support being connected to a pair of lateral transmission belts driven by an electric motor to move the mobile support vertically in both directions. Control means use optical sensors to detect the position of the top coin in the stack when said coin is in the expulsion position just on top of the tube's upper opening, and activate the driving of a transversal thrusting element to expel said top coin from the device.

Patent GB-A-2. 327 795 discloses a device similar to the one described in said patent GB-A-2 278 221, but in which the said transversal thrusting element is mounted in a unit which moves together with the stack of coins near the expulsion position so as to maintain a suitable position relationship between the thrusting element and the coin to be expelled. The thrusting element is driven by an electric motor and a rotary cam mechanism. The driving of the mobile support comprises a transmission belt driven by an electric motor for vertically dragging a carriage to which the mobile support is connected by an arm passed through a longitudinal groove in the tube.

Patent GB-A-2 369 228 describes a device limited to storing coins and giving change. The device consists of a coin stacking tube with an upper open end in a working surface. Means are provided to move the stack of coins upwards inside the tube until a desired number of coins project from the working surface, from where they can be removed manually by an operator. The device includes a control unit with a coin release button. Each time said button is pressed, said movement means are activated to produce a movement equivalent to the thickness of a coin. As in previous constructions, the said movement means include a mobile support located inside the tube and connected to a nut that is coupled to a spindle driven to rotate in both directions, the nut being joined to the mobile support by an arm passed through a longitudinal groove in the tube wall. The tube is reloaded through said upper open end of the tube.

All the documents cited above have in common the arrangement of a vertical, or slightly tilted tube for storing stacked coins and a mobile support inside the tube for supporting the stack of coins, and driving means for moving the mobile support together with the stack of coins up and down inside the tube. With the arrangement of a single tube, the storage capacity is limited, and the possibility of increasing said storage capacity consists in providing a longer tube. However, a longer tube implies increasing the height of the coin insertion groove with respect to the floor, or the need to include additional mechanisms for lifting the coins to the upper inlet and exit end of the tube. It is important to bear in mind that strict regulations are in force regarding the maximum distances between the coin insertion groove and the change collection box, and between each of these and the floor for reasons of ergonomics and adaptation for handicapped users. Another possibility for increasing the storage capacity consists in providing various devices for each type of coin, which has the drawback of multiplying the drives, since a mobile support and expulsion mechanism drive is required for each device, requiring more drives and a more complex electronic control to link the various devices to a single coin insertion groove and a single change collection box, and occupying a larger area, which is difficult to find inside many vending machines and the like.

The objective of this invention is to provide a solution to the above drawbacks, providing a LIFO storage device which is used to receive and dispense coins or tokens that has a large storage capacity, is compact and is equipped with a single movement mechanism and a single coin or token removal mechanism.

### BRIEF EXPOSITION OF THE INVENTION

The preceding objective and others are achieved, according to the present invention, by providing a LIFO storage device which is used to receive and dispense coins or tokens, which includes a plurality of storage tubes for coins or tokens of one and the same kind with an individual movement mechanism for the stack of coins or tokens inside all the tubes and an individual coin or token removal mechanism that is common for all tubes.

The LIFO storage device of the present invention comprises various associated tubes (at least two) forming a set of tubes arranged in relation to a spindle. Each tube comprises an upper opening for the inlet and exit of coins or tokens and a mobile support inside the tube for supporting said stack of coins or tokens. Driving means including a nut mechanism joined to said spindle, are adapted to move the mobile supports together with the respective stacks of coins or tokens up and down inside said tubes, so as to receive and dispense coins or tokens, respectively. Adjacent to said upper inlet and exit openings of the tubes, a support is arranged in which an inlet conduit and expulsion means are mounted. Driving means are adapted to produce a relative movement between said set of tubes and said support so as place said tubes sequentially in different relative positions, in each of which said inlet conduit outlet is faced the upper opening of one of the tubes and the expulsion means are faced the upper opening of another of said tubes.

This arrangement provides a significantly large storage capacity in a relatively reduced space or, more particularly, using tubes with a comparable length to that of the state of the art devices, which, for example in a vending machine, allows the coin or token insertion groove and the change collection box to be placed within the range of heights off the floor that is recommended by ergonomic standards, with an important increase in the storage capacity.

In one embodiment example, the spindle is parallel to the tubes, which are arranged at equal angular intervals around the spindle and at equal distances with respect to the spindle axis. Each mobile support is connected to said nut by means of an arm passed through a longitudinal slot on the respective tube, and the nut is operatively coupled to the spindle. The support is arranged to rotate vis-à-vis a coaxial axis with the spindle and said driving means are adapted to make the support rotate in both directions and place it sequentially in different angular positions in relation to the set of tubes, said angular positions corresponding to the different relative positions mentioned above. Said expulsion means comprise an upper end stop element mounted and guided to move freely with respect to the support in a direction parallel to the tube axis, in order to make contact with the upper coin or token in the corresponding stack or with part of the edge of the upper opening. To said upper end stop element at least one expulsion element is attached that is driven in a transversal direction vis-à-vis the stack of coins or tokens, dragging the top coin or token in the stack. This expulsion element projects underneath the upper end stop element a length that is less than the thickness of the coins or tokens.

The device includes means for lifting the upper end stop element with respect to the support and then letting it fall onto the top coin or token in the following stack in passing from one angular position to the next angular position, and each tube includes an extendible upper portion that can be moved coaxially with respect to the tube without the possibility of rotating and without affecting the stack of coins or tokens inside the tube. Each extendible upper portion has a projection coupled to a guide groove in the support at a suitable height for maintaining the extendible upper portion in a maximum extended position. Also, said projection can be coupled to another guide groove associated with the upper end stop element when said upper end stop element is in a maximum lift position and rotates between one angular position and the following angular position. This way, the movements of the extendible upper portion of the tube from which a coin is going to be expelled, are linked to the movements of the upper end stop element.

In each extendible upper portion said upper inlet and exit opening is defined and comprises an exit notch on one edge of said upper opening sufficiently sized to allow one coin or token to pass through edgeways. The said means for lifting and then letting the upper end stop element drop with respect to the support, comprise a cam surface arranged perimetrally around the set of tubes, which defines a series of low portions in angular positions corresponding to each tube and an elevation between each angular position corresponding to a tube and the angular position corresponding to the following tube. The upper end stop element has an associated cam follower that can rest in a sliding or rolling manner on said cam surface, so that the upper end stop element experiences a lifting movement between each angular position corresponding to one tube and the angular position corresponding to the following tube, where it is detached from the projection of the extendible upper portion of one tube and coupled to the projection of the extendible upper portion of the following tube. The descending movement of the upper end stop element with respect to the support can be gravitational or it can be driven by the force of an elastic element loaded during the upward movement thereof.

Advantageously, said rotary drive means are arranged to make the spindle and the support rotate in unison selectively in one or other rotation direction, and the thread pitch of the spindle is selected such that the nut, in a complete turn, produces a movement equal to the thickness of a coin or token. The driving action of the expulsion element can be produced by dedicated driving means that comprise, for example, an electromagnet, or it can be advantageously linked to said rotary drive means for the support and spindle. In this second case, the expulsion element comprises at least one thrusting tab attached to the upper end stop element and arranged to make contact on one side of the edge of the top coin or token in the stack when the mobile support rotates, and press the top coin or token against an oblique stationery surface on the opposite side to make it slide through said outlet notch.

In this way, a single drive motor is used to drive all the mechanisms in a co-ordinated manner, which simplifies control and ensures high reliability and precision at a relatively low cost.

### BRIEF DESCRIPTION OF THE DRAWINGS

The above characteristics, as well as others and advantages will be more obvious from the following detailed description of embodiment examples, with reference to the attached drawings, in which:

FIG. 1 is an exploded perspective view of an embodiment example of the LIFO storage device which is used to receive and dispense coins or tokens according to this invention;

FIG. 2 is a perspective view of the support, upper end stop and extendible upper portions of the device in FIG. 1;

FIG. 3 is an upper plane view of the device in FIG. 1;

FIG. 4 is a cross-sectional view along the plane IV-IV in FIG. 3;

FIG. 5 is a cross-sectional view along the plane V-V in FIG. 3;

FIG. 6 is an exploded perspective view of another embodiment example of the LIFO storage device which is used to receive and dispense coins or tokens according to this invention,

FIG. 7 is a perspective view of the device in FIG. 6 assembled;

FIG. 8 is an elevation perspective view, of a single part body inside which the walls of the said tubes are formed;

FIG. 9 is a view from below of the FIG. 8, and

FIG. 10 is an elevation view of a single-part body placed between the coin inlet and the upper opening of the tubes.

### DETAILED DESCRIPTION OF SOME EMBODIMENT EXAMPLES

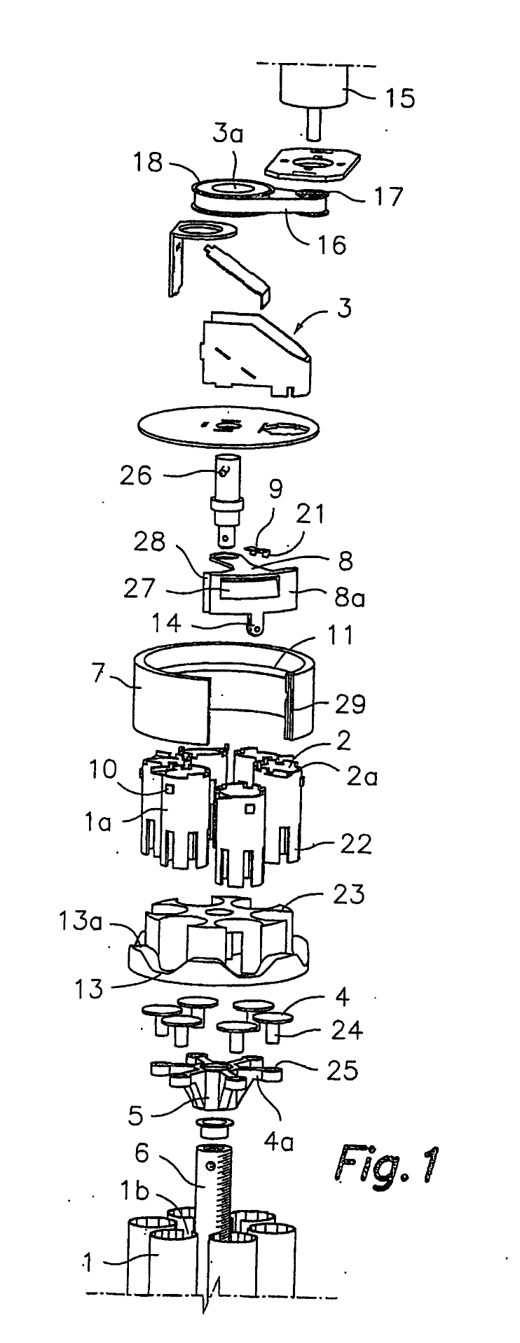

First of all, FIG. 1 shows an exploded view of an embodiment example of the LIFO device which is used to receive and dispense coins or tokens according to this invention, which comprises a plurality of tubes 1, showing six of them in the illustrated example, but equally there could be at least two or more than six, arranged to store coins or tokens stacked inside them. Each of the tubes 1 includes an extendible upper portion 1a that can be moved coaxially with respect to tube 1 without the possibility of rotating and without affecting the stack of coins or tokens inside tube 1, and each extendible upper portion 1a has an upper inlet/outlet opening 2 where the coins or tokens are introduced into or removed from the tubes 1. For said axial movement without the possibility of rotation to be possible, next to the lower edge of each extendible upper portion 1a there is a series of parallel longitudinal grooves between which fingers 22 are defined that are housed in a sliding manner in corresponding parallel longitudinal grooves, formed in the upper end of the corresponding stationery portion of tube 1.

Tubes 1 are attached to a base part 23 that keeps them associated to one another forming a set of tubes 1 arranged at equal angular intervals around a spindle 6 that is parallel to tubes 1, and at equal distances from the axis of spindle 6. Inside each tube 1 a mobile support 4 is slidingly arranged, which acts as a support for the corresponding stack of coins or tokens and as an element for moving said stack within the tube, and each mobile support 4 is connected to a nut 5 coupled to spindle 6 by means of an arm 4a passed through a longitudinal slot 1b in the respective tube 1, and nut 5 is coupled to spindle 6. In the illustrated example, mobile supports 4 have a lower projection 24 which inserts into a ring 25 joined to the end of each arm 4a.

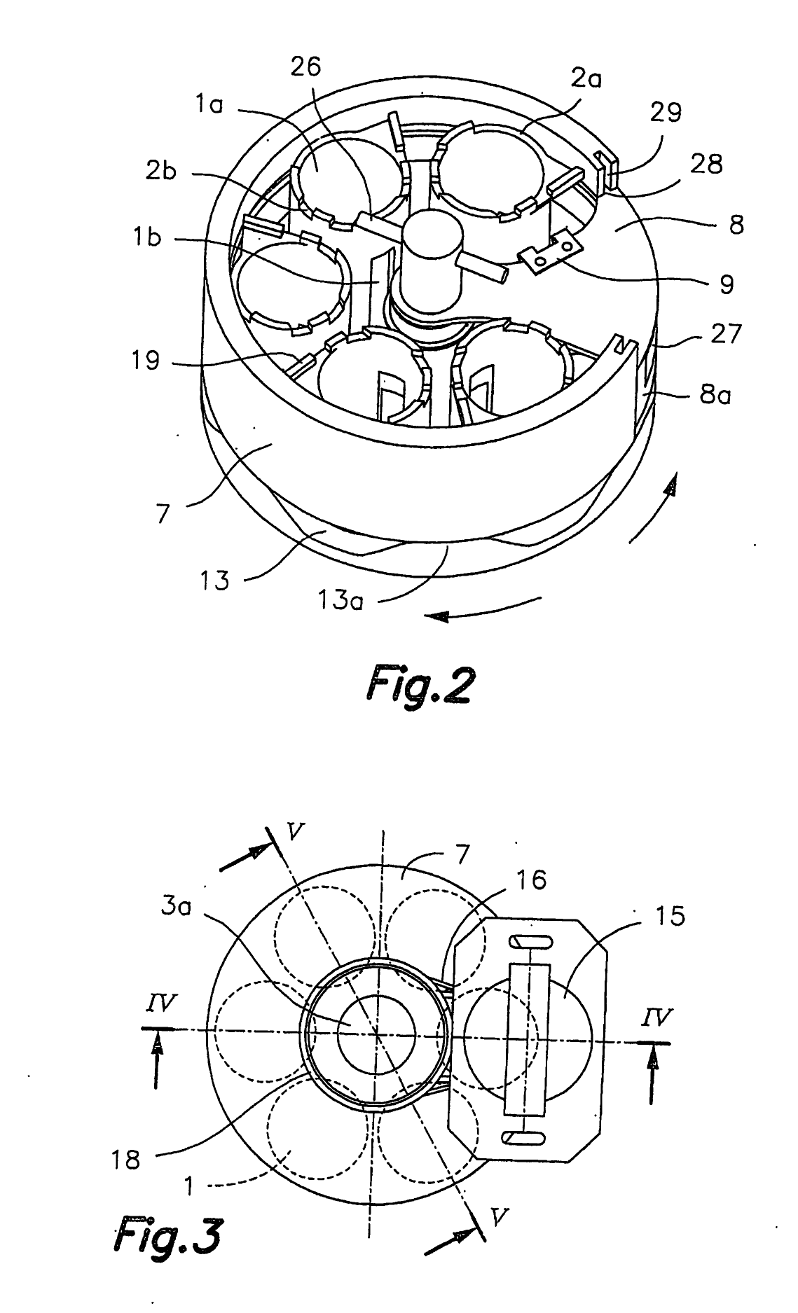

In the top part of the set of tubes 1, above said base piece 23, a support 7 is arranged (best shown in FIG. 2) in which a coin or token inlet conduit 3 and coin or token expulsion means 8, 9 are mounted. Said support 7 is connected integrally to spindle 6, for example by means of a pin 26, and driving means are provided for producing a relative rotational movement between said set of tubes 1, and said support 7 so as to place said tubes sequentially in different relative positions. Typically, the set of tubes 1 and base part 23 remain stationery while the spindle and mobile support are driven by said driving means to rotate in both directions and place the support 7 sequentially in different angular positions with respect to the set of tubes 1 corresponding to the said different relative positions. In each of said angular positions an outlet of said inlet conduit 3 lies faced the upper opening 2 of one of the tubes 1, and the expulsion means 8, 9 lie faced the upper opening 2 of another of said tubes 1.

Now also with reference to FIG. 2, expulsion means 8, 9 comprise an upper end stop element 8 guided to move freely with respect to support 7 in a direction parallel to the axis of tube 1 to make contact with the top coin or token in the corresponding stack, and at least one expulsion element 9 linked to said upper end stop element 8. The upper end stop element 8 is joined to an outer portion 8a where a coin or token outlet window 27 is defined. On the sides of said outer portion 8a ribs 28 are formed that insert into guide grooves 29 formed vertically in support 7 to guide the movement of upper end stop element 8.

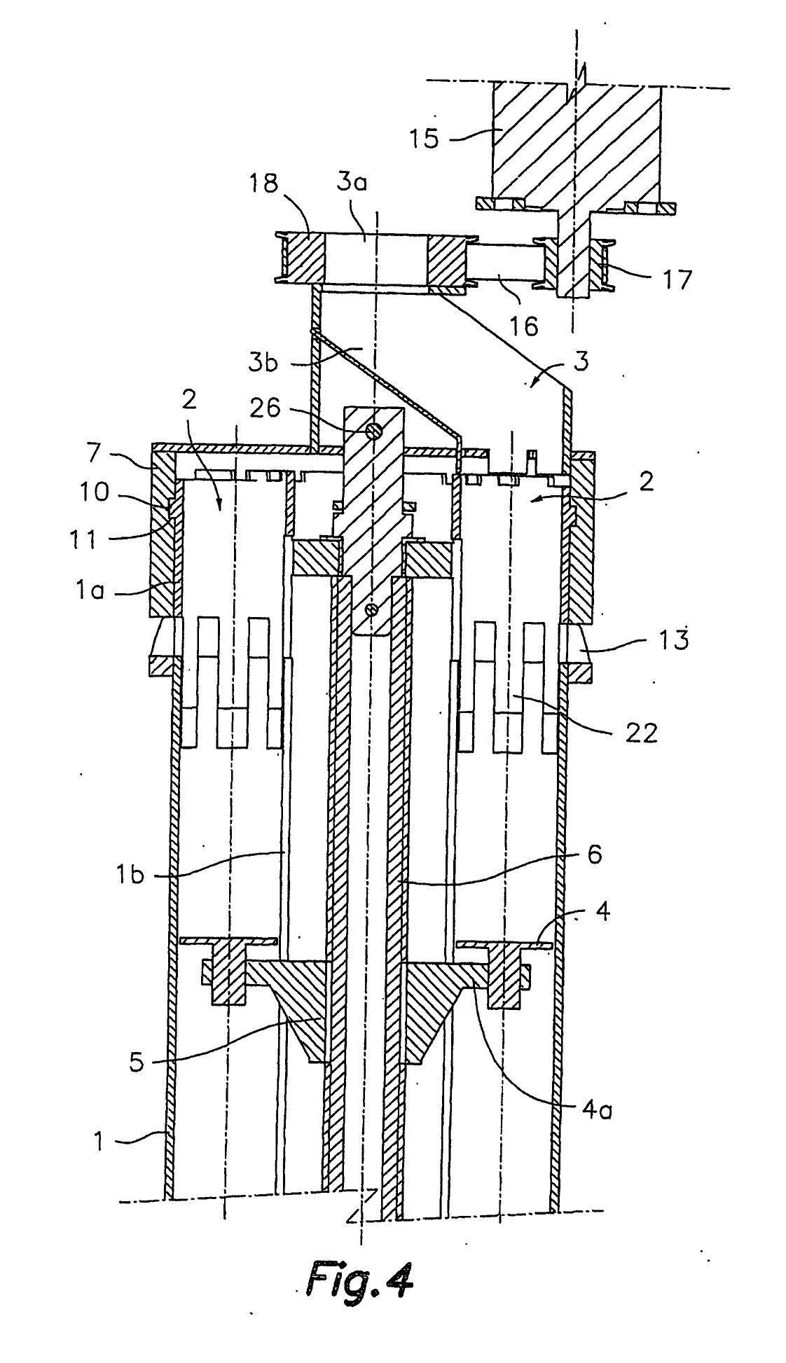

Said expulsion element 9 is driven so that it moves in a transverse direction to the stack of coins or tokens, dragging the top coin or token in the stack. In the embodiment example illustrated in FIGS. 1 to 5, expulsion element 9 is joined to upper end stop element 8 and projects underneath for a length that is less than the thickness of the coins or tokens, and the driving of the upper end stop 8 is linked to said rotary driving means of support 7 and spindle 6. In the illustrated example, expulsion element 9 comprises a pair of thrust tabs 21 arranged so as to make contact on one side of the edge of the top coin or token in the stack when mobile support 7 rotates in a particular rotation direction, to press the top coin or token against an oblique stationery surface 19 on the opposite side of one edge of upper opening 2 of extendible upper portion 1a of tube 1 to make it slide through an exit slot 2a provided on said edge, where a pair of notches 2b are also formed from side to side to allow the passage of said thrust tabs 21. So, each time the driving means cause support 7 and spindle 6 to rotate in the determined rotation direction, thrust tabs 21 expel the coin. Also, the thread on spindle 6 is such that nut 5, in one complete turn, produces a movement that is equal to the thickness of a coin or token so as to again place the following top coin in the stack in an expulsion position.

In order to ensure a correct position relationship between expulsion element 9 and the top coin in the stack, which is going to be expelled, means are provided for lifting upper end stop element 8 and then letting it drop with respect to support 7 in passing from one angular position to the following angular position. Said means comprise a cam surface 13 formed on base part 23 and arranged perimetrally around the set of tubes 1 and a cam follower 14 connected to outer portion 8a of upper end stop element 8. Cam 13 defines an elevation 13a between each angular position corresponding to one tube 1 and the angular position corresponding to the following tube 1. Since upper end stop element 8 can move vertically with respect to support 7, cam follower 14, which rests in a sliding or rolling manner on said cam surface 13, produces a lifting action and subsequent descent of upper end stop element 8 each time said element passes from one angular position to the next. The downward movement of upper end stop element 8 with respect to support 7 is advantageously gravitational, although equally it could be driven, for example, by the force of an elastic element (not shown) that is loaded during the upwards movement. What is important is that there is no forced link between cam follower 14 and cam 13 in the downwards movements, which allows upper end stop element 8 to be disposed on the top coin in the stack and interrupt its fall, therefore achieving a suitable relative position between expulsion element 9 and the coin to be expelled irrespective of the variations in the height of the stack owing to the coin manufacturing tolerances, dirt stuck to the coins or other factors.

Each extendible upper portion 1a has a projection 10 (FIG. 1) attached to a guide groove 11 in support 7 at a suitable height for keeping extendible upper portion 1a in a maximum extended position. Said projection 10 can also be attached to another guide groove 12 (FIG. 5) formed in outer portion 8a of upper end stop element 8 when said upper end stop element 8 is in a maximum elevation position between one angular position and the following angular position. This way, the movements of extendible upper portion 1a are linked to the movements of upper end stop element 8.

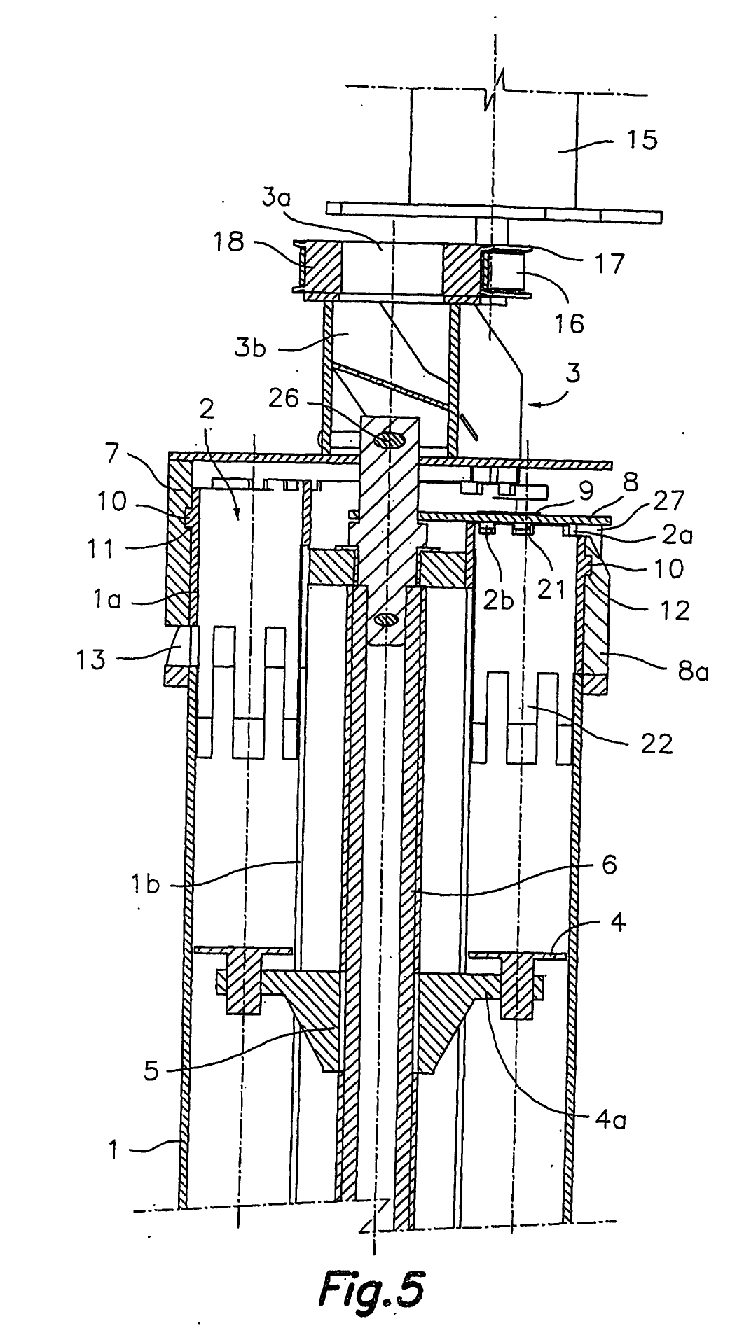

FIG. 4 shows the outlet of inlet conduit 3 faced the upper opening of extendible upper portion 1a of a tube 1, while FIG. 5 shows upper end stop element 8 in a low position of cam 13, keeping the corresponding extendible upper portion 1a in said low position.

The rotary driving means include an electric motor 15 with an output shaft connected to support 7 by means of a transmission, which in the embodiment example shown in FIGS. 1 to 5, comprises a flexible transmission element, such as a belt 16 or chain, arranged between a driving pulley 17 attached to the output shaft of the motor and a driven pulley 18 attached to support 7 coaxially with respect to spindle 6. As shown in FIGS. 4 and 5, said driven pulley 18 comprises a central passage 3a through which said coin or token inlet conduit 3 is installed, so that a central section thereof does not move during the rotation of support 7, while an end opening of a tilted section 3b, which extends downwards and outwards from said central section, can lie faced upper opening 2 of each tube 1 in the different angular positions.

In an alternative embodiment example, not shown, said transmission includes a direct or indirect gear between a toothed driving wheel attached to the output shaft of the motor and a toothed driven wheel attached to support 7 coaxially with respect to spindle 6, said toothed driven wheel also including a central passage for said coin or token inlet conduit 3 to extend into a section 3b that tilts downwards and outwards ending in an opening lying faced upper opening 2 of each tube 1 in the different angular positions.

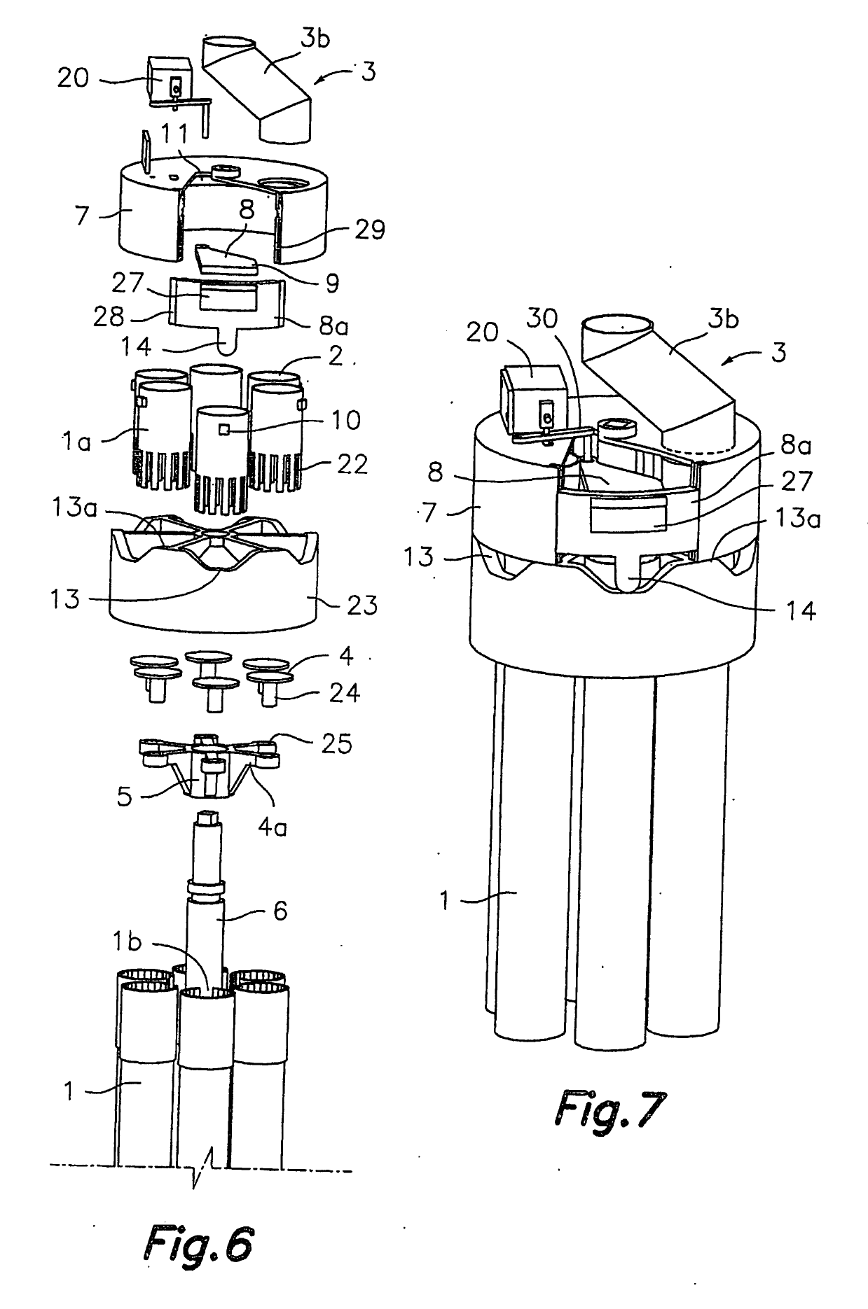

FIGS. 6 and 7 show another embodiment example of the device of this invention, which includes driving means dedicated to said driving action of expulsion element 9. Otherwise, the construction of this second embodiment example is very similar to that of the embodiment example described with reference to FIGS. 1 to 5, and therefore its description is omitted.

In FIGS. 6 and 7, expulsion element 9 is joined below to upper end stop element 8, which is a separate part from outer portion 8a and is guided into outer portion 8a so as to move in a substantially radial direction with respect to the axis of spindle 6. Said dedicated driving means comprise an electromagnet 20 connected to upper end stop element 8 by means of a lever mechanism 30 so as to move the top coin or token in the stack through said outlet notch 2a.

Advantageously, each tube 1 is made up of various modular sections provided with releasable joining means that make it possible to adapt the coin or token storage capacity by adding or removing modular sections according to the particular application, and it can include conventional means for detecting the passage of incoming and/or exiting coins or tokens, which are connected to a meter.

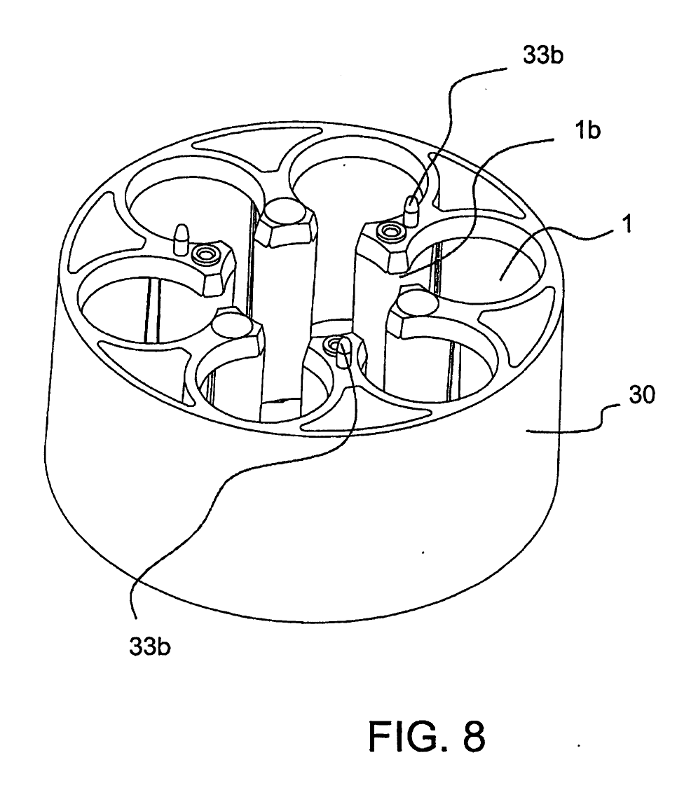

As illustrated in FIGS. 8, 9 and 10, different parts of this device can be manufactured using single part bodies. This permits various advantages, particularly in manufacturing, since these bodies can be produced by injection and made to be very resistant, at a fairly reduced manufacturing cost.

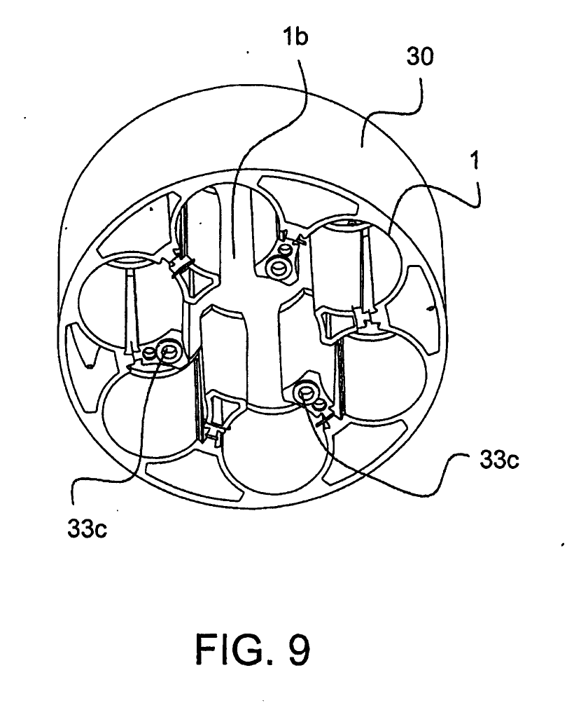

So, as for body 30 (FIGS. 8 and 9), the walls of said tubes 1 and the respective slots 1b are formed inside it, and since it is modular, the length of said tubes 1 can be selected. It order to apply said modular option, the releasable joining means 33 must be joined, i.e.: lugs 33b (FIG. 8) must be inserted into orifices 33c (FIG. 9) of the single part body 30 immediately above.

Said body 30 is made up of one part, that is, it can be a single part or it can be formed by joining various parts (not illustrated in the drawings) and for example, assembling them.

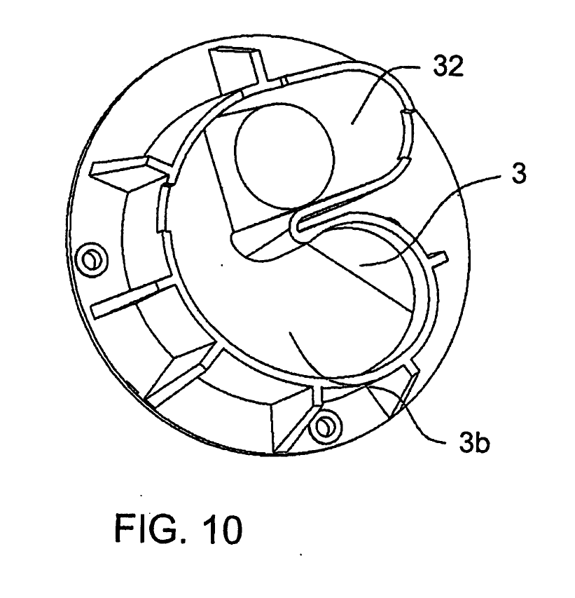

With respect to body 31 (FIG. 10), which is a single part in this embodiment, it includes the coin or token inlet conduit 3, with a section 3b tilted downwards and outwards, ending in an opening lying faced to the upper opening of each tube in the different angular positions.

Also said tilted section 3b adopts a spiral configuration, with an upper reinforcement 32 at the end of its projection, in this embodiment reinforcement 32 is vertical. Owing to said reinforcement 32 and the spiral configuration, there is no need to ensure that the coin falls into inlet conduit 3, because the coin always reaches the upper opening in an operational manner, because if the coin reaches the end of the tilted section 3b edgeways, reinforcement 32 will push it down so that it is in an operative position.

Also, thanks to the actual spiral configuration, during this tilted section, through inertia, the coin is placed in an operative position when it reaches the end of the tilted section.

The embodiment examples described above are purely illustrative and do not limit the invention, and a person skilled in the art will be able to introduce variations and modifications without departing from said scope, which is defined in the attached claims.

1-32. (canceled)

33. LIFO storage device used to receive and dispense coins or tokens, of the type comprising:
at least one tube for storing coins or tokens arranged to form a stack;
an upper opening in said tube for the entry and exit of coins or tokens;
an inlet conduit for coins or tokens with an outlet faced said upper opening;
a mobile support inside tube to support said stack of coins or tokens;
driving means that include a nut and spindle mechanism for moving mobile support together with the stack of coins or tokens up and down inside said tube in order to receive and dispense coins or tokens, respectively; and
expulsion means driven to expel the top coin in the stack, adjacent to upper opening of tube, towards an outlet, characterised in that it comprises:
at least two of said tubes forming a set of tubes arranged in relation to spindle;
respective mobile supports inside tubes and connected to said nut and spindle mechanism;
a support in which said inlet conduit and said expulsion means are mounted; and
driving means for producing a relative movement between said set of tubes an said support which places said tubes sequentially in different relative positions, in each of which said outlet of inlet conduit lies faced upper opening of one of tubes, of which there are at least two, and the expulsion means lie faced upper opening of another of said tubes.

34. Device according to claim 33, characterised in that spindle is parallel to tubes.

35. Device according to claim 34, characterised in that said tubes are arranged at equal angular intervals around spindle and at equal distances from the axis of spindle.

36. Device according to claim 35, characterised in that the walls of said tubes and the respective slots, of which there are at least two, are formed by means of at least one body, made up of at least one part.

37. Device according to claim 36, characterised in that each mobile support is connected to said nut by means of an arm passed through a longitudinal slot of the respective tube, and nut is coupled to spindle.

38. Device according to claim 37, characterised in that said support is arranged to rotate in relation to a coaxial axis with spindle and said driving means are adapted to rotate support in both directions and place it sequentially in different angular positions in relation to the set of tubes corresponding to said different relative positions.

39. Device according to claim 38, characterised in that said expulsion means comprise an upper end stop element guided to move freely with respect to support in a direction parallel to the axis of tube in order to make contact with the top coin or token in the corresponding stack or with part of the edge of upper opening, and at least one expulsion element linked to said upper end stop element.

40. Device according to claim 39, characterised in that said expulsion element is driven to move in a transverse direction to the stack of coins or tokens, dragging the top coin or token in the stack.

41. Device according to claim 40, characterised in that said expulsion element is linked to upper end stop element and projects underneath it for a length that is less than the thickness of the coins or tokens.

42. Device according to claim 41, characterised in that it includes means for lifting upper end stop element with respect to support and then letting it drop onto the top coin or token in the following stack in passing from one angular position to the following angular position.

43. Device according to claim 42, characterised in that each tube includes an extendible upper portion that can be moved coaxially with respect to tube without the possibility of rotation and without affecting the stack of coins or tokens inside tube, each extendible upper portion including a projection attached to a guide groove on support at a suitable height for keeping extendible upper portion in a position of maximum extension, with said projection being able to be attached to another guide groove associated with upper end stop element when said upper end stop element is in a position of maximum lift between one angular position and the following angular position to link the movements of extendible upper portion to the movements of upper end stop element.

44. Device according to claim 43, characterised in that in each extendible upper portion said upper opening is defined and it comprises an outlet notch on one edge of said upper opening that is appropriately sized to allow a coin or token to pass through edgeways.

45. Device according to claim 44, characterised in that said means for lifting and then letting upper end stop element drop with respect to support, include a cam surface arranged perimetrally around the set of tubes and a cam follower that is connected to upper end stop element and can rest in a sliding or rolling manner of said cam surface, which defines an elevation between each angular position corresponding to one tube and the angular position corresponding to the following tube.

46. Device according to claim 45, characterised in that the downward movement of upper end stop element with respect to support is gravitational.

47. Device according to claim 45, characterised in that the downward movement of upper end stop element with respect to support is driven by the force of an elastic element that is loaded during the upward movement.

48. Device according to claim 45, characterised in that spindle is operatively connected to said rotary driving means for support.

49. Device according to claim 48, characterised in that said rotary driving means are provided to rotate spindle and support in unison selectively in one rotation direction or another.

50. Device according to claim 49, characterised in that the thread pitch of spindle is such that nut, in a complete turn, produces a movement equal to the thickness of a coin or token.

51. Device according to claim 50, characterised in that said rotary driving means include an electric motor connected to support by a transmission, and an attachment between support and spindle.

52. Device according to claim 51, characterised in that said transmission comprises a belt or chain arranged between a driving pulley attached to the output shaft of the motor and a driven pulley attached to support coaxially vis-à-vis spindle, said driven pulley including a central passage so that said coin or token inlet conduit extends into a section tilted downwards and outwards, ending in an opening that can lie faced upper opening of each tube in the different angular positions.

53. Device according to claim 51, characterised in that said transmission comprises a direct or indirect gear between a toothed driving wheel attached to the output shaft of the motor and a toothed driven wheel attached to support coaxially vis-à-vis spindle, said toothed driven wheel including a central passage so that said coin or token inlet conduit extends into a section tilted downwards and outwards, ending in an opening that can lie faced upper opening of each tube in the different angular positions.

54. Device according to claim 40, characterised in that it comprises driving means dedicated to said driving action of expulsion element.

55. Device according to claim 54, characterised in that said dedicated driving means comprise an electromagnet connected to expulsion element, which is guided to move in a substantially radial direction with respect to the axis of spindle and move the top coin or token in the stack through said outlet notch.

56. Device according to claim 55, characterised in that expulsion element is joined to upper end stop element and both are guided to be moved together by said electromagnet.

57. Device according to claim 40, characterised in that said driving action of expulsion element is linked to said rotary driving means of support and spindle.

58. Device according to claim 57, characterised in that expulsion element includes at least one thrusting tab attached to upper end stop element and provided to make contact on one side of the edge of the top coin or token in the stack when mobile support rotates, and pres the top coin or token against an oblique stationery surface on the opposite side to slide it through said outlet notch.

59. Device according to claim 58, characterised in that on said edge of upper opening at least one pair of notches are provided to allow the passage of said thrusting tab, of which there is at least one.

60. Device according to claim 43, characterised in that each extendible upper portion has next to its lower edge a series of parallel longitudinal grooves between which fingers are defined and housed in a sliding manner in corresponding parallel longitudinal grooves, formed in the corresponding stationery part of tube.

61. Device according to claim 33, characterised in that the coin or token inlet conduit, with a downward tilted section ending in an opening that can lie faced upper opening of each tube in the different angular positions, consists of a body made up of at least one part.

62. Device according to claim 61, characterised in that the said tilted section also adopts a spiral configuration, with an upper reinforcement at the end of its projection.

63. Device according to claim 33, characterised in that each tube is made up of various modular sections provided with releasable joining means that make it possible to adapt the coin or token storage capacity by adding or removing modular sections according to the particular application.

64. Device according to claim 33, characterised in that it includes sensors that detect the passage of incoming and/or exiting coins or tokens, connected to a meter device.
